(19) United States
(12) Patent Application Publication
(10) Pub. No.: US 2015/0304426 A1
(43) Pub. Date: Oct. 22, 2015

(54) METHOD OF MANAGING AN APPLICATION IN A SECURE ELEMENT

(71) Applicant: GEMALTO INC., Austin, TX (US)

(72) Inventors: Yingzi HE, Austin, TX (US); Olivier Yon, Meudon (FR)

(73) Assignee: GEMALTO INC., Austin, TX (US)

(21) Appl. No.: 14/256,395

(22) Filed: Apr. 18, 2014

(51) Int. Cl. H04L 29/08

(52) U.S. Cl. CPC H04L 67/14; H04L 67/02

(57) ABSTRACT

The invention is a method of managing an application embedded in a secure element which is able to communicate with another device through a HTTP session. The application has previously registered for being triggered when a preset event will occur into the secure element. The triggering of the application is blocked as a HTTP session is in progress between the secure element and the device when the preset event occurs.

### FIELD OF THE INVENTION

The present invention relates to methods of managing an application embedded in a secure element. It relates particularly to methods of managing an application which is embedded in secure element that communicates through a HTTP (HyperText Transfer Protocol) or HTTPS (HyperText Transfer Protocol Secure) session.

### BACKGROUND OF THE INVENTION

A secure element is either a tamper-resistant physical component able to store data and to provide services in a secure manner or a software component providing a trusted storage area and trusted services. In general, a secure element has access to a limited amount of memory, a processor with limited capabilities and is devoid of battery. For instance a UICC (Universal Integrated Circuit Card) is a secure element which embeds SIM applications for telecommunication purposes. A secure element can be installed, fixedly or not, in a terminal, like a mobile phone for example. In some cases, the terminals are constituted by machines that communicate with other machines for M2M (Machine to Machine) applications.

A secure element can be in the format of a smart card, or may be in any other format such as for example but not limited to a packaged chip as described in PCT/SE2008/050380, SD© card or any other format. A UICC can be used in mobile terminals in GSM, CDMA or UMTS networks for instance. The UICC ensures network authentication, integrity and security of all kinds of personal data.

It is known to solder or weld a secure element in a host device, in order to get it dependent of this host device. This is done in M2M (Machine to Machine) applications. The same objective is reached when a chip (a secure element) containing a Payment application, SIM or USIM applications and files is contained in the host device. The chip is for example soldered to the mother-board of the host device or machine and constitutes an embedded-secure element (eSE).

A secure element may contain a plurality of applications which may be separately triggered.

A secure element may have the capability to communicate using HTTP(s) with a distant device like a server for example.

In the state of the art, a secure element may include a registering mechanism allowing an embedded application to register for being triggered when a predefined event occurs into the secure element. When an embedded application is started via this mechanism, the application may perform some action that lead to a reboot of the secure element. Such reboot may be induced by a Card Application Toolkit (CAT) Refresh command send by a SIM card which leads the connected telecom terminal to reset the SIM card. If a HTTP session was in progress at this time, the HTTP connection is lost and must be re-established. The establishment of a new HTTP session lead to a waste of time and a waste of network resources.

There is a need for preventing an application to start a treatment that will break a HTTP session already established.

### SUMMARY OF THE INVENTION

An object of the invention is to solve the above mentioned technical problem.

The object of the present invention is a method of managing an application embedded in a secure element which is able to communicate with a device through a HTTP(s) session. The application is configured to register for being triggered when a preset event occurs into the secure element. The method comprises the step of blocking triggering of the application as a HTTP(s) session is in progress between the secure element and the device when the preset event occurs.

Advantageously, the application may be a toolkit applet and the preset event may be the EVENT_PROACTIVE_HANDLER_AVAILABLE event as defined by ETSI TS 102 241.

Advantageously, the secure element may include a toolkit handler able to manage running of the application and the method may comprise the further step of preventing the application to directly access the toolkit handler when the application is going to send a Card Application Toolkit command belonging to a preset list as a HTTP session is in progress.

Another object of the invention is a secure element comprising an application and able to communicate with a device through a HTTP(s) session. The application is configured to register for being triggered when a preset event occurs into the secure element. The secure element comprises an agent configured to block triggering of the application as a HTTP(s) session is in progress between the secure element and the device.

Advantageously, the application may be a toolkit applet and the preset event may be the EVENT_PROACTIVE_HANDLER_AVAILABLE event as defined by ETSI TS 102 241.

Advantageously, the secure element may include a toolkit handler able to manage running of the application and the application may be configured to delay directly access the toolkit handler when the application is going to send a Card Application Toolkit command belonging to a preset list as a HTTP(s) session is in progress.

Advantageously, the secure element may be a UICC.

Another object of the invention is a system comprising a plurality of secure elements according to the invention and a remote server configured to communicate with the plurality of secure elements via HTTP(s) sessions.

### BRIEF DESCRIPTION OF THE DRAWINGS

Other characteristics and advantages of the present invention will emerge more clearly from a reading of the following description of a number of preferred embodiments of the invention with reference to the corresponding accompanying drawing in which:

FIG. 1 depicts schematically an example of architecture of a secure element which communicates with a device through a HTTP session according to the invention.

### DETAILED DESCRIPTION OF THE PREFERRED EMBODIMENTS

The invention may apply to any types of secure element able to manage applications which can register to an event. In particular, the present invention may also apply to secure element using the HyperText Transfer Protocol Secure, usually called HTTPS. In this specification, the secured electronic token is a SIM card but it could be any other kind of secure element able to use the HTTP or HTTPS mechanisms. In this specification, the secure element is connected to a host machine. In particular, the host machine may be a mobile phone or telecom terminal. The secure element accesses the remote device through the host machine. Alternatively, HTTP(S) messages may be directly exchanged between the secure element and the remote device without any intermediate host machine.

Thanks to the invention, the messages transmitted through an HTTP(s) session can be fully exchanged without inopportune breaking.

An advantage of the invention is to save time which may be required for a re-establishment of a broken HTTP(s) session.

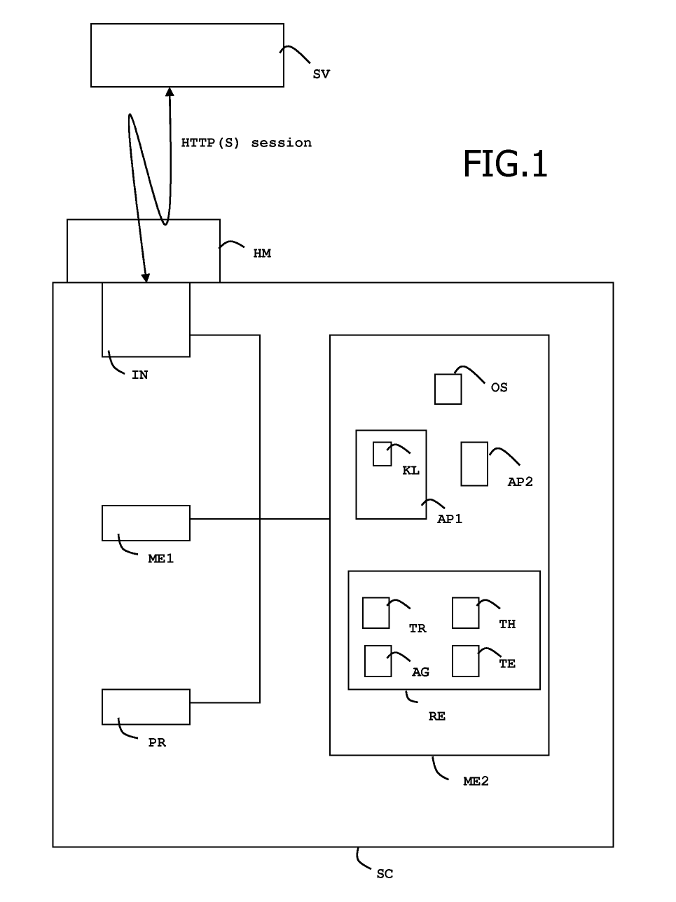

FIG. 1 shows the architecture of a secure element SC of UICC type according to a preferred embodiment of the invention.

The secure element SC comprises a working memory ME1 of RAM type, a non volatile memory ME2, a computing module PR and a physical communication interface IN. The non volatile memory ME2 comprises an operating system OS which may contain a Java Virtual Machine.

The physical communication interface IN is adapted to communicate with a host machine HM. In this example, the host machine is a mobile phone.

The non volatile memory ME2 comprises two applications AP1 and AP2 and an execution environment RE. The application AP1 comprises a preset list KL of Card Application Toolkit (CAT) commands (also named Toolkit commands) as defined by ETSI TS 102 223. For instance, the preset list KL may include Display Text and Refresh commands.

Preferably, the applications AP1 and AP2 are toolkit applets complying with Java Card.

Preferably, the execution environment RE is the CAT runtime environment as defined by ETSI TS 102 241 V9.1.0. The execution environment RE comprises a toolkit registry TR, a toolkit handler TH and a triggering entity TE. In addition, the execution environment RE comprises an agent AG.

The toolkit registry TR is able to handle the registration information of the Toolkit applets and their link to the JCRE (Java Card Runtime Environment as specified in Runtime Environment Specification, Java Card Platform 3.0.1 Classic Edition) registry.

The toolkit handler TH is able to manage running of the toolkit application.

When a targeted event occurs, the triggering entity TE is able to request the information from the toolkit registry TR, which toolkit applets are registered to the targeted event. The triggering entity TE then triggers the toolkit applet.

The agent AG is configured to block the triggering of the registered applet as a HTTP(s) session is in progress between the secure element SC and another device. The agent AG is configured to release the blocking mode when the current HTTP(s) session is closed.

Preferably, the event is the EVENT_PROACTIVE_HANDLER_AVAILABLE event as defined by ETSI TS 102 241.

Advantageously, the application AP1 may be configured to delay direct access to the toolkit handler TH when the application AP1 is going to send a Card Application Toolkit command belonging to the preset list KL as a HTTP session is in progress. Thanks to this additional feature, the secure element avoids to send a Toolkit (e.g. CAT) command to the connected host device which may lead to a reboot of the secure element SC.

Advantageously, a flag is managed in HTTP(S) processing module. When HTTP(s) channel is open, the flag is set to tell the agent AG that the HTTP(s) session is ongoing. After HTTP(s) channel is close, the flag is reset to tell the agent AG to release the blocking mode.

The secure element SC is able to communicate with a device SV through a HTTP(s) session. In a preferred embodiment, the device SV is a remote server. The device SV may be able to manage a fleet of secure elements through a plurality of simultaneous HTTP(s) sessions.

It is to be noted that even if the triggering of the registered applet is blocked during a pending HTTP(s) session, the applet can register to any event while the HTTP(s) session is in progress.

According to an embodiment of the invention, the first step of the method corresponds to the registration of the applet AP1 to a specific event into the toolkit registry TR to be triggered when the specific event occurs into the secure element SC. Typically, the specific event may be an event which reflects the fact that the context of the execution environment RE is ready to execute the application AP1.

At a second step, the specific event occurs and the triggering of the application AP1 is blocked as a HTTP(s) session is in progress between the secure element SC and the device SV.

Advantageously, the triggering of the application AP1 is then performed a soon as the HTTP(s) session is closed.

Advantageously, the method may comprise the step of preventing the application AP1 to directly access the toolkit manager TH (able to manage the running of the application AP1) when the application is about to send a CAT command belonging to the preset list KL if a HTTP(s) session is in progress.

Advantageously, the preset list KL may be stored outside the application AP1. For example, the preset list KL may be stored in a common file or database (with a fixed identifier/path) readable by any application installed into the secure element SC. The preset list KL may also be stored in the operating system OS which controls the secure element and application may use a dedicated API to access the list KL.

When an HTTP session is on-going, no matter which application is using this HTTP session to communicate with device SV, other applications which register to the specific event (like EVENT_PROACTIVE_HANDLER_AVAILABLE) will be delayed to trigger after HTTP session. For instance, if a HTTP session is currently active and used by the application AP1, the invention will prevent the application AP2 to be triggered when the preset event occurs. (Assuming that AP2 has previously registered to this preset event.)

It must be understood, within the scope of the invention, that the above-described embodiments are provided as non-limitative examples. In particular, the secure element may include applications which are not toolkit application and the invention may apply to the management of all kinds of application.

1. A method of managing an application (AP1) embedded in a secure element (SC) which is able to communicate with a device (SV) through a HTTP session, the application (AP1) being configured to register for being triggered when a preset event occurs into the secure element (SC),
wherein said method comprises the step of blocking triggering of the application (AP1) as a HTTP session is in progress between the secure element (SC) and the device (SV) when the preset event occurs.

2. A method according to claim 1, wherein the application (AP1) is a toolkit applet and wherein the preset event is the EVENT_PROACTIVE_HANDLER_AVAILABLE event as defined by ETSI TS 102 241.

3. A method according to claim 2, wherein the secure element (SC) includes a toolkit handler (TH) able to manage running of the application (AP1) and wherein said method comprises the further step of preventing the application (AP1) to directly access the toolkit handler (TH) when the application (AP1) is going to send a Card Application Toolkit command belonging to a preset list (KL) as a HTTP session is in progress.

4. A secure element (SC) comprising an application (AP1) and able to communicate with a device (SV) through a HTTP session, the application (AP1) being configured to register for being triggered when a preset event occurs into the secure element (SC),
wherein said secure element (SC) comprises an agent (AG) configured to block triggering of the application (AP1) as a HTTP session is in progress between the secure element (SC) and the device (SV).

5. A secure element (SC) according to claim 4, wherein the application (AP1) is a toolkit applet and wherein the preset event is the EVENT_PROACTIVE_HANDLER_AVAILABLE event as defined by ETSI TS 102 241.

6. A secure element (SC) according to claim 5, wherein the secure element (SC) includes a toolkit handler (TH) able to manage running of the application (AP1) and wherein the application (AP1) is configured to delay direct access to the toolkit handler (TH) when the application (AP1) is going to send a Card Application Toolkit command belonging to a preset list (KL) as a HTTP session is in progress.

7. A secure element (SC) according to claim 4, wherein the secure element (SC) is a UICC.

8. A system comprising a plurality of secure elements according to claim 4 and a remote server configured to communicate with the plurality of secure elements via HTTP sessions.
